(19) United States
(12) Patent Application Publication
(10) Pub. No.: US 2024/0230524 A1
(43) Pub. Date: Jul. 11, 2024

(54) Photoreaction Evaluation Apparatus

(71) Applicant: SHIMADZU CORPORATION, Kyoto (JP)

(72) Inventor: Takahiro TAMAKI, Kyoto-shi, Kyoto (JP)

(73) Assignee: SHIMADZU CORPORATION, Kyoto (JP)

(21) Appl. No.: 18/558,169

(22) PCT Filed: Mar. 7, 2022
(86) PCT No.: PCT/JP2022/009626

§ 371 Date: Mar. 19, 2024

(30) Foreign Application Priority Data
May 6, 2021 (JP) 2021-078640

(51) Int. Cl. G01N 21/31; G01J 3/42; G01N 21/25

(52) U.S. Cl. CPC G01N 21/31; G01J 3/42; G01N 21/255; G01N 2021/3125

(57) ABSTRACT

A measurement light source is arranged on a rear surface side of a surface at a sample position irradiated with light by an irradiation light source and a detector is arranged on a front surface side of the surface at the sample position irradiated with light by the irradiation light source. A radiation intensity calculator calculates a radiation intensity at each wavelength of irradiation light from the irradiation light source based on a first detected intensity distribution, a second detected intensity distribution, and radiation characteristics of a standard light source. An irradiated photon number calculator calculates the number of irradiated photons at each wavelength of irradiation light from the irradiation light source based on the radiation intensity at each wavelength.

### TECHNICAL FIELD

The present disclosure relates to a photoreaction evaluation apparatus.

### BACKGROUND ART

As a sample is irradiated with light by an excitation light source, another substance, fluorescence, or the like is generated. Such a phenomenon is called a photoreaction. A quantum yield is used as an indicator of evaluation of the photoreaction. The quantum yield is expressed as (the number of molecules of a substance generated in a sample by irradiation with light)/(the number of photons absorbed by the sample). The excitation light source is herein called an irradiation light source.

In order to calculate the quantum yield, the number of photons absorbed by the sample should be measured. In this case, since the number of photons of light emitted to the sample by the irradiation light source (which is called the number of irradiated photons below) is different depending on the irradiation light source, the number of irradiated photons should be calibrated.

Then, a method of calibration of the number of irradiated photons with the use of a chemical actinometer that has an already known number of absorbed photons per chemical reaction at a specific wavelength has been proposed. In addition, a method of calibration of the number of irradiated photons with the use of an optical power meter that measures energy of light has been proposed. For example, in the section of the background art in PTL 1, a method of calibration of the number of irradiated photons with the use of a chemical actinometer or an optical power meter is described.

### CITATION LIST

### Patent Literature

Patent Literature 1: Japanese Patent Laying-Open No. 2015-34717

### SUMMARY OF INVENTION

### Technical Problem

The number of irradiated photons, however, varies depending on a wavelength of light. Therefore, the number of irradiated photons should be calibrated with the use of the chemical actinometer in accordance with the wavelength of light from the irradiation light source. In this case, since a peak of absorption by the chemical actinometer is somewhat broad, it is difficult to accurately measure the number of irradiated photons at each wavelength. Since the optical power meter is normally unable to measure a wavelength distribution of energy of light, it is difficult to calibrate an accurate wavelength distribution of the number of irradiated photons. Therefore, when an irradiation light source that generates light having a wide wavelength range is employed for a photoreaction, it is difficult to accurately calibrate a distribution of the number of irradiated photons over the wide wavelength range. In addition, a sample is various in shape, and it is difficult to measure the number of irradiated photons depending on arrangement of the irradiation light source or a measurement apparatus.

The present invention provides a photoreaction evaluation apparatus and a photon number calculation method in which an irradiation light source or a measurement apparatus is arranged in consideration of a shape of a sample, the photoreaction evaluation apparatus and the photon number calculation method allowing accurate calculation of a distribution of the number of irradiated photons dependent on a wavelength not only when an irradiation light source that generates light having a specific wavelength is used but also when an irradiation light source that generates light having a wide wavelength range is used.

### Solution to Problem

A photoreaction evaluation apparatus according to one aspect of the present disclosure is a photoreaction evaluation apparatus that evaluates a photoreaction of a sample arranged at a sample position. The photoreaction evaluation apparatus includes an irradiation light source arranged to irradiate the sample position with light as irradiation light and provided as being replaceable with a standard light source that generates white light, a uniform irradiation lens attached to the irradiation light source, the uniform irradiation lens allowing irradiation of a surface at the sample position with light at a uniform intensity, a spectrophotometer including a measurement light source and a detector, the measurement light source being arranged to irradiate the sample position with light, the detector being arranged to detect an intensity distribution of light from the sample position, an intensity distribution obtaining unit that obtains as a first detected intensity distribution, an intensity distribution of light detected by the detector while the sample position where no sample is present is irradiated with light by the standard light source and the sample position is not irradiated with light by the measurement light source and obtains as a second detected intensity distribution, an intensity distribution of light detected by the detector during a first measurement operation while the sample position where no sample is present is irradiated with light as irradiation light by the irradiation light source and the sample position is not irradiated with light by the measurement light source, a radiation intensity calculator that calculates a radiation intensity at each wavelength of irradiation light from the irradiation light source based on the first detected intensity distribution obtained by the intensity distribution obtaining unit, the second detected intensity distribution obtained by the intensity distribution obtaining unit, and radiation characteristics of the standard light source, and an irradiated photon number calculator that calculates as the number of irradiated photons, the number of photons at each wavelength of irradiation light from the irradiation light source based on the radiation intensity at each wavelength calculated by the radiation intensity calculator. The measurement light source is arranged on a rear surface side of a surface at the sample position irradiated with light by the irradiation light source. The detector is arranged on a front surface side of the surface at the sample position irradiated with light by the irradiation light source.

### Advantageous Effects of Invention

According to the present invention, a distribution of the number of irradiated photons dependent on a wavelength can accurately be calculated not only when an irradiation light source that generates light having a specific wavelength is used but also when an irradiation light source that generates light having a wide wavelength range is used.

### BRIEF DESCRIPTION OF DRAWINGS

FIG. 1 is a block diagram showing a configuration of a photoreaction evaluation apparatus according to one embodiment.

FIG. 2 is a block diagram showing a configuration of a photoreaction evaluation apparatus to be compared with.

FIG. 3 is a block diagram showing a functional configuration of a data processing unit in

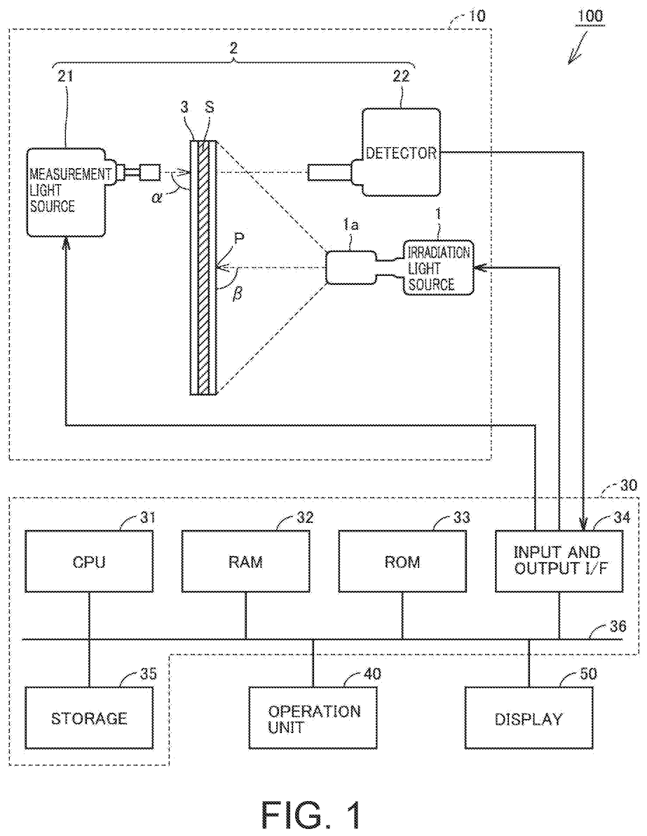

FIG. 1.

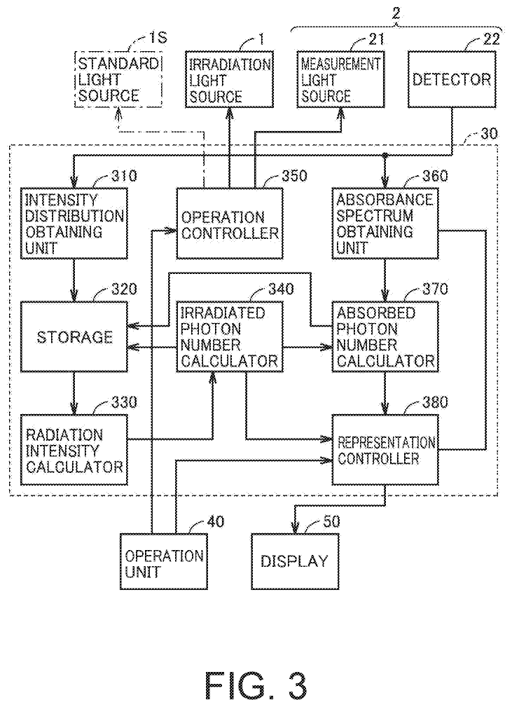

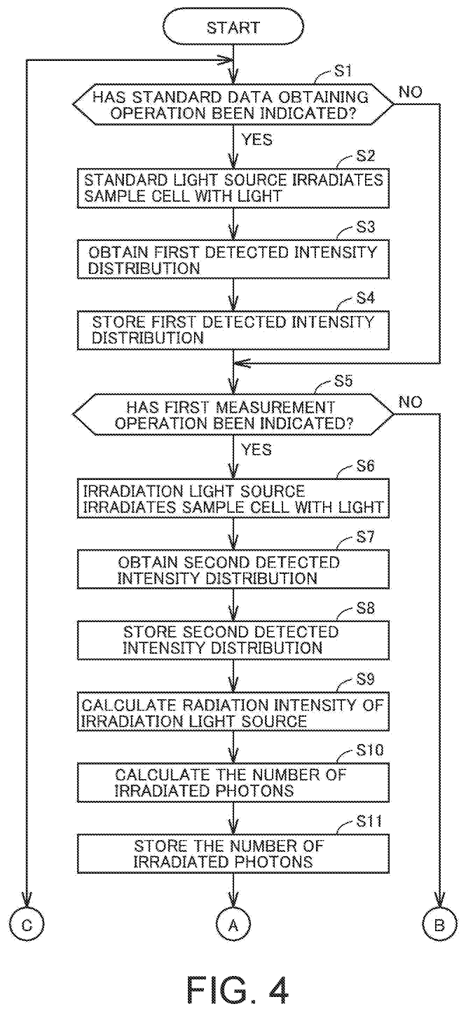

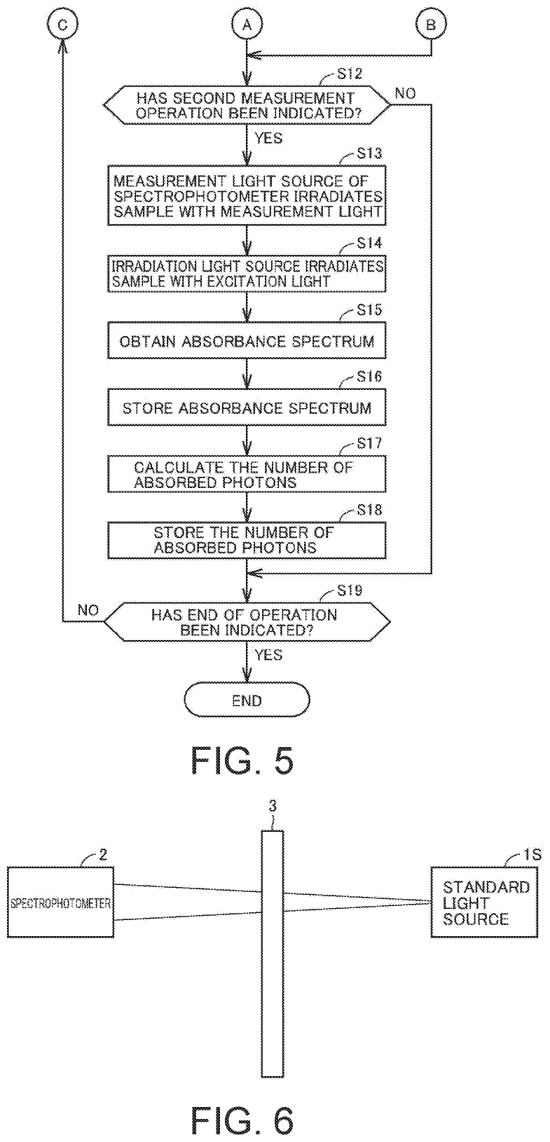

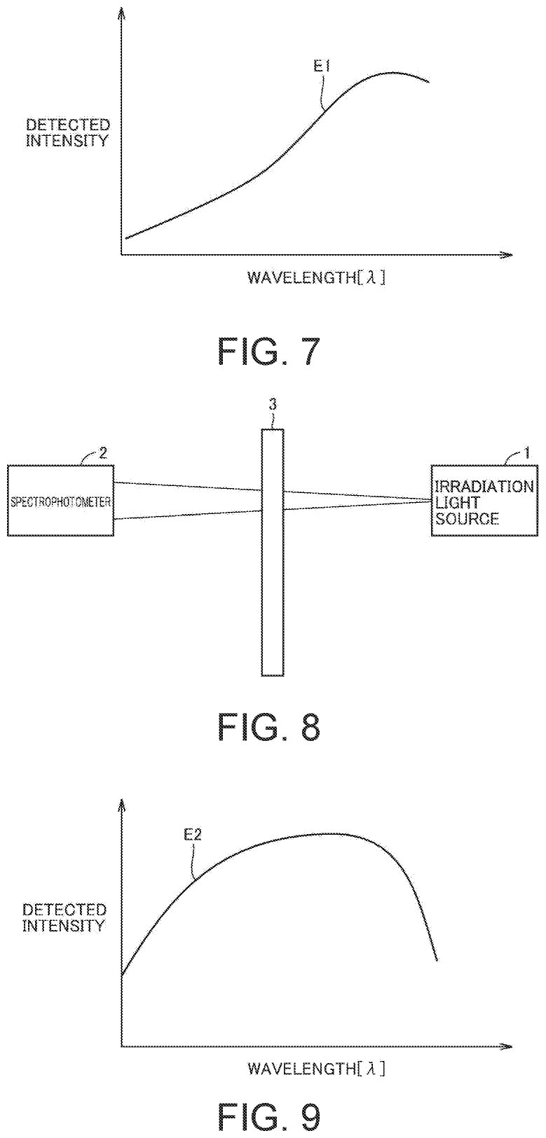

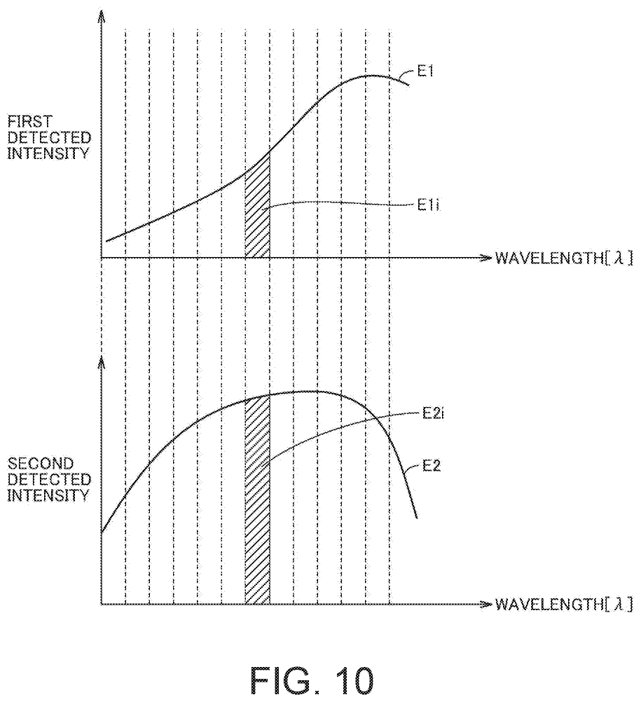

FIG. 4 is a flowchart showing a photoreaction evaluation operation by the data processing unit in FIG. 3.

FIG. 5 is a flowchart showing the photoreaction evaluation operation by the data processing unit in FIG. 3.

FIG. 6 is a diagram for illustrating a standard data obtaining operation.

FIG. 7 is a diagram showing an exemplary first detected intensity distribution obtained in the standard data obtaining operation.

FIG. 8 is a diagram for illustrating a first measurement operation.

FIG. 9 is a diagram showing an exemplary second detected intensity distribution obtained in the first measurement operation.

FIG. 10 is a diagram for illustrating a method of calculating a radiation intensity at each wavelength of an irradiation light source.

### DESCRIPTION OF EMBODIMENTS

A photoreaction evaluation apparatus and a photon number calculation method according to an embodiment of the present disclosure will be described below in detail with reference to the drawings.

### (1) Configuration of Photoreaction Evaluation Apparatus

FIG. 1 is a block diagram showing a configuration of a photoreaction evaluation apparatus according to one embodiment. A photoreaction evaluation apparatus 100 in FIG. 1 includes a measurement unit 10 and a data processing unit 30. Measurement unit 10 includes an irradiation light source 1, a spectrophotometer 2, and a sample cell 3. A sample S is set in sample cell 3. In the present embodiment, a position of sample cell 3 corresponds to a sample position. In the present embodiment, evaluation of a photoreaction of sample S includes evaluation of the number of photons absorbed in the photoreaction of sample S.

Irradiation light source 1 irradiates sample cell 3 with light as excitation light. A light source that generates light having a specific wavelength, light having a specific wavelength range, multi-wavelength light, or white light can be employed as irradiation light source 1. Irradiation light source 1 may be various light sources such as a light emitting diode (LED), a xenon lamp, a mercury lamp, or a deuterium lamp. A uniform irradiation lens 1a is attached to a portion of emission of light from irradiation light source 1. Uniform irradiation lens 1a is an optical element for irradiation of the entire surface at a position of sample cell 3 with light from irradiation light source 1 at a uniform intensity. With uniform irradiation lens 1a, any position in sample cell 3 can be irradiated with light at a substantially uniform intensity. In particular, when sample S in a form of a film is set in sample cell 3, sample S should be irradiated with light at the uniform intensity at the position thereof irradiated with measurement light. Uniform irradiation lens 1a should only be an optical element that allows irradiation with light at a uniform intensity, such as a telecentric lens or a rod lens.

Spectrophotometer 2 includes a measurement light source 21, a spectroscope (not shown), and a detector 22. In the present embodiment, a multi-channel spectrophotometer including a polychromator can be employed.

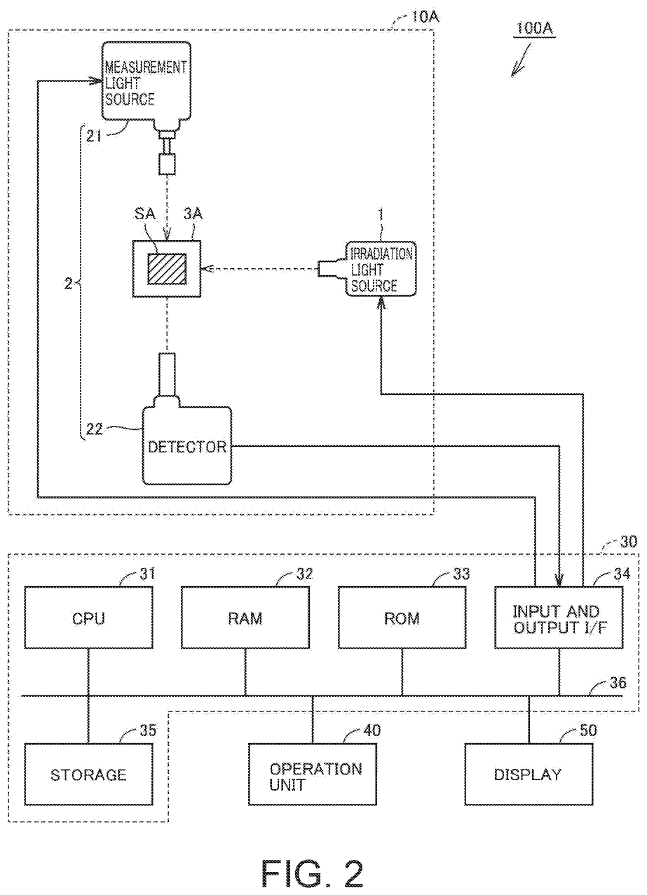

Arrangement of irradiation light source 1, spectrophotometer 2, and sample cell 3 in measurement unit 10 will now be described. Initially, arrangement in an example where a sample to be set in a sample cell is cubic or a solution sample is set in a cubic sample cell will be described as arrangement to be compared with. FIG. 2 is a block diagram showing a configuration of a photoreaction evaluation apparatus 100A to be compared with. Photoreaction evaluation apparatus 100A shown in FIG. 2 is the same in configuration as photoreaction evaluation apparatus 100 shown in FIG. 1 except for arrangement of irradiation light source 1, spectrophotometer 2, and sample cell 3 in a measurement unit 10A. Therefore, a feature in photoreaction evaluation apparatus 100A shown in FIG. 2 the same as that in photoreaction evaluation apparatus 100 shown in FIG. 1 has the same reference character allotted.

In measurement unit 10A, measurement light from measurement light source 21 of spectrophotometer 2 is orthogonal to irradiation light from irradiation light source 1 in a sample cell 3A. Detector 22 of spectrophotometer 2 is arranged at a position opposed to measurement light source 21 with sample cell 3A lying therebetween. A sample SA set in sample cell 3A does not spread in a surface irradiated with measurement light, and hence uniform irradiation lens 1a does not have to be provided in irradiation light source 1.

In the arrangement of measurement unit 10A shown in FIG. 2, however, in measurement of the sample in the form of the film, only a part of the sample can be irradiated with light from irradiation light source 1. In addition, a side surface of the sample (a portion of a film thickness) should be irradiated with light. It has thus been difficult to measure the number of photons.

In photoreaction evaluation apparatus 100 according to the present embodiment, with arrangement of measurement unit 10 shown in FIG. 1, the number of photons of sample S in the form of the film set in sample cell 3 can be measured. Specifically, in measurement unit 10, irradiation light source 1 and measurement light source 21 are arranged such that the direction of irradiation with light from irradiation light source 1 is substantially in parallel to the direction of irradiation with light from measurement light source 21 of spectrophotometer 2. In other words, the directions of irradiation with light from irradiation light source 1 and measurement light source 21 are substantially orthogonal to the surface of sample cell 3 (an angle α≅90° and an angle β≅90°).

Furthermore, irradiation light source 1 is provided with uniform irradiation lens 1a to irradiate the entire surface at the position of sample cell 3 with light therefrom at a uniform intensity. Therefore, since any position in a plane in sample cell 3 is irradiated with light 1 at the uniform intensity by irradiation light source 1, any position in the plane of sample cell 3 can be irradiated with light from measurement light source 21 to enable measurement by detector 22 of spectrophotometer 2. As can be seen in FIG. 1, as a horizontal distance (in an upward-downward direction in the figure) is longer from a position P of a surface of sample cell 3 orthogonal to the direction of irradiation with light from irradiation light source 1, an angle formed between the surface of sample cell 3 and irradiation light is smaller. Therefore, measurement with detector 22 of spectrophotometer 2 by irradiation with light by measurement light source 21 at a position more distant from position P is less likely to be affected by irradiation light reflected at the surface of sample cell 3.

Uniform irradiation lens 1a does not have to allow irradiation of the entire surface with light at the uniform intensity at the position of sample cell 3. The portion to be irradiated with light at the uniform intensity at the position of sample cell 3 owing to uniform irradiation lens 1a should only be irradiated with light from measurement light source 21 to enable measurement with detector 22 of spectrophotometer 2. In other words, detector 22 of spectrophotometer 2 should only conduct measurement of the portion of sample S irradiated with irradiation light from uniform irradiation lens 1a and measurement light from measurement light source 21. So long as sample S in the form of the film can maintain its shape during measurement, sample cell 3 does not have to be provided and sample S alone may be provided at the position of sample cell 3.

Arrangement of measurement unit 10 shown in FIG. 1 is by way of example, and at least measurement light source 21 should only be arranged on the rear surface side of the surface of sample cell 3 irradiated with light by irradiation light source 1 and detector 22 should only be arranged on the front surface side of the surface of sample cell 3 irradiated with light by irradiation light source 1. In other words, irradiation light source 1 and detector 22 should only be arranged on the same side with respect to sample cell 3, and irradiation light source 1 and measurement light source 21 should only be arranged on sides opposite to each other with sample cell 3 lying therebetween. Preferably, measurement light source 21 and detector 22 are arranged at positions opposed to each other with sample cell 3 lying therebetween. In other words, measurement light source 21 and detector 22 are preferably arranged on a straight line with sample cell 3 lying therebetween.

Further preferably, an angular difference between the direction of irradiation with light by irradiation light source 1 and the direction of irradiation with light by measurement light source 21 is within a prescribed range. Though FIG. 1 illustrates that the angles are set as angle α≅90° and angle β≅90° and the angular difference between the direction of irradiation with light by irradiation light source 1 and the direction of irradiation with light by measurement light source 21 is 0 (zero), the angular difference within the prescribed range may be allowable so long as the angular difference does not affect the measurement. Under the condition of angle α≅90° and angle β≅90° as in FIG. 1, the direction of irradiation with light by irradiation light source 1 and the direction of irradiation with light by measurement light source 21 are in parallel to each other. Such arrangement of irradiation light source 1, spectrophotometer 2, and sample cell 3 in measurement unit 10 can allow measurement of the number of photons even when sample S set in sample cell 3 is a film sample or a sample in the form of the film.

Data processing unit 30 includes a central processing unit (CPU) 31, a random access memory (RAM), 32, a read only memory (ROM) 33, an input and output interface (I/F) 34, and a storage 35. CPU 31, RAM 32, ROM 33, input and output I/F 34, and storage 35 are connected to a bus 36. An operation unit 40 and a display 50 are connected to bus 36 of data processing unit 30. Operation unit 40 includes a keyboard, a mouse, or the like and it is operated by a user for input of various commands and data into data processing unit 30. Display 50 includes a liquid crystal display, an organic electroluminescence (EL) display, or the like and shows various types of data or the like.

Storage 35 includes a storage medium such as a semiconductor memory or a memory card, and a photoreaction evaluation program is stored therein. RAM 32 is used as a work area of CPU 31. A system program is stored in ROM 33. CPU 31 controls irradiation light source 1 and spectrophotometer 2 through input and output I/F 34 by executing the photoreaction evaluation program stored in storage 35 on RAM 32 and receives an output signal from spectrophotometer 2 through input and output I/F 34. A photoreaction evaluation method which will be described later is thus performed. The photoreaction evaluation method includes a photon number calculation method.

Photoreaction evaluation apparatus 100 performs a standard data obtaining operation with the use of a standard light source 1S (FIG. 3) which will be described later, a first measurement operation with the use of irradiation light source 1, and a second measurement operation to conduct measurement of sample S.

### (2) Functional Configuration of Data Processing Unit 30

FIG. 3 is a block diagram showing a functional configuration of data processing unit 30 in FIG. 1. As shown in FIG. 3, data processing unit 30 includes an intensity distribution obtaining unit 310, a storage 320, a radiation intensity calculator 330, an irradiated photon number calculator 340, an operation controller 350, an absorbance spectrum obtaining unit 360, an absorbed photon number calculator 370, and a representation controller 380. Functions of constituent elements (310 to 380) above are performed by execution by CPU 31 in FIG. 1, of a photoreaction evaluation program which is a computer program stored in a storage medium (recording medium) such as storage 35. At least one or all of the constituent elements of data processing unit 30 may be implemented by hardware such as electronic circuitry.

During the standard data obtaining operation, instead of irradiation light source 1, standard light source 1S shown with a chain dotted line in FIG. 3 is attached to measurement unit 10 (FIG. 1). Standard light source 1S is a light source that generates light having a wavelength range equal to or wider than a wavelength range of light generated by irradiation light source 1. A white light source is employed as standard light source 1S. Though the white light source is implemented, for example, by an LED that generates white light, another white light source may be employed. Standard light source 1S is a light source that generates light having a wide wavelength range. A radiation intensity distribution over all wavelengths of light generated by standard light source 1S is called radiation characteristics of standard light source 1S below. The radiation characteristics include a radiation intensity at each wavelength of light generated by standard light source 1S. The radiation characteristics of standard light source 1S are accurately measured in advance. Since spectrophotometer 2 has wavelength sensitivity distribution characteristics dependent on a wavelength, the radiation intensity distribution of light generated by standard light source 1S is normally different from an intensity distribution of light from standard light source 1S detected by spectrophotometer 2.

Intensity distribution obtaining unit 310 obtains the intensity distribution of light detected by detector 22 of spectrophotometer 2 as a first detected intensity distribution during the standard data obtaining operation. The first detected intensity distribution refers to an intensity distribution of light detected over the all wavelengths of white light emitted to sample cell 3 by standard light source 1S. Intensity distribution obtaining unit 310 obtains an intensity distribution of light detected by detector 22 of spectrophotometer 2 as a second detected intensity distribution during the first measurement operation. The second detected intensity distribution refers to the intensity distribution of light detected in the wavelength range of light emitted to sample cell 3 by irradiation light source 1. When irradiation light source 1 is the white light source, the second detected intensity distribution is the intensity distribution of light detected over the all wavelengths. When irradiation light source 1 is the light source that generates light having a specific wavelength or light having a specific wavelength range, the second detected intensity distribution is the intensity distribution of light detected at the specific wavelength or in the specific wavelength range.

In storage 320, the first detected intensity distribution obtained by intensity distribution obtaining unit 310 during obtainment of standard data and the second detected intensity distribution obtained by intensity distribution obtaining unit 310 during the first measurement operation are stored. In storage 320, the radiation characteristics of standard light source 1S are stored in advance. Furthermore, the number of irradiated photons calculated by irradiated photon number calculator 340 and the number of absorbed photons calculated by absorbed photon number calculator 360 which will be described later are stored in storage 320.

Radiation intensity calculator 330 calculates the radiation intensity at each wavelength of irradiation light source 1 based on the first detected intensity distribution, the second detected intensity distribution, and the radiation intensity at each wavelength of standard light source 1S stored in storage 320, during the first measurement operation. Details of a calculation method will be described later.

Irradiated photon number calculator 340 calculates the number of photons of light emitted to sample cell 3 by irradiation light source 1 (which is called the number of irradiated photons below) based on the radiation intensity at each wavelength calculated by radiation intensity calculator 330. Details of a calculation method will be described later.

Operation controller 350 controls an operation of each constituent element of data processing unit 30 and controls operations of standard light source 1S, irradiation light source 1, and measurement light source 21 of spectrophotometer 2 so as to perform the standard data obtaining operation, the first measurement operation, and the second measurement operation based on an operation onto operation unit 40 by a user.

Absorbance spectrum obtaining unit 360 obtains the intensity distribution of light detected by detector 22 of spectrophotometer 2 as an absorbance spectrum during the second measurement operation. Absorbed photon number calculator 370 calculates the number of photons absorbed at each wavelength based on the absorbance spectrum obtained by absorbance spectrum obtaining unit 360 and the number of irradiated photons calculated by irradiated photon number calculator 340. Details of a calculation method will be described later.

Representation controller 380 has display 50 show the number of irradiated photons calculated by irradiated photon number calculator 340, the number of absorbed photons calculated by absorbed photon number calculator 370, and the absorbance spectrum obtained by absorbance spectrum obtaining unit 360 based on an operation onto operation unit 40.

### (3) Operation of Photoreaction Evaluation Apparatus 100

FIGS. 4 and 5 are flowcharts showing a photoreaction evaluation operation by data processing unit 30 in FIG. 3. FIG. 6 is a diagram for illustrating the standard data obtaining operation. FIG. 7 is a diagram showing an exemplary first detected intensity distribution obtained in the standard data obtaining operation. FIG. 8 is a diagram for illustrating the first measurement operation. FIG. 9 is a diagram showing an exemplary second detected intensity distribution obtained in the first measurement operation. FIG. 10 is a diagram for illustrating a method of calculating a radiation intensity at each wavelength of irradiation light source 1. The ordinate in FIGS. 7, 9, and 10 represents a detected intensity at each wavelength detected by spectrophotometer 2 and the abscissa represents a wavelength 2.

The photoreaction evaluation operation by photoreaction evaluation apparatus 100 includes the standard data obtaining operation, the first measurement operation, and the second measurement operation as above. The photoreaction evaluation operation in FIGS. 4 and 5 is performed by execution of the photoreaction evaluation program by CPU 31 in FIG. 3.

The standard data obtaining operation is performed, for example, when photoreaction evaluation apparatus 100 is installed or maintained. Standard data includes the first detected intensity distribution and the radiation characteristics (the radiation intensity at each wavelength) of standard light source 1S. The first measurement operation is performed, for example, daily. The second measurement operation is performed at the time of measurement of sample S.

In the standard data obtaining operation, a worker attaches standard light source 1S instead of irradiation light source 1 to operation unit 40. Sample S is not set in sample cell 3. Operation controller 350 determines whether or not the standard data obtaining operation has been indicated through operation unit 40 (step S1). When the standard data obtaining operation has been indicated, operation controller 350 controls standard light source 1S to irradiate sample cell 3 with light (step S2). Thus, as shown in FIG. 6, sample cell 3 is irradiated with light radiated from standard light source 1S and light from sample cell 3 is incident on spectrophotometer 2. At this time, sample cell 3 is not irradiated with light from measurement light source 21 of spectrophotometer 2. Arrangement of standard light source 1S, spectrophotometer 2, and sample cell 3 shown in FIG. 6 is different from actual arrangement, and it is schematically shown for the sake of simplification of description.

Intensity distribution obtaining unit 310 obtains the intensity distribution of light detected by detector 22 of spectrophotometer 2 as the first detected intensity distribution (step S3). FIG. 7 shows relation between the detected intensity and wavelength 2 as a first detected intensity distribution E1. Intensity distribution obtaining unit 310 has obtained first detected intensity distribution E1 stored in storage 320 (step S4). The standard data obtaining operation is thus completed.

In the first measurement operation, the user attaches irradiation light source 1 to measurement unit 10. Sample S is not set in sample cell 3. Operation controller 350 determines whether or not the first measurement operation has been indicated through operation unit 40 (step S5). When the first measurement operation has been indicated, operation controller 350 controls irradiation light source 1 to irradiate sample cell 3 with light (step S6). Thus, as shown in FIG. 8, sample cell 3 is irradiated with light radiated from irradiation light source 1 and light from sample cell 3 is incident on spectrophotometer 2. At this time, sample cell 3 is not irradiated with light from measurement light source 21 of spectrophotometer 2. Arrangement of irradiation light source 1, spectrophotometer 2, and sample cell 3 shown in FIG. 8 is different from actual arrangement and it is schematically shown for the sake of simplification of description.

Intensity distribution obtaining unit 310 obtains the intensity distribution of light detected by detector 22 of spectrophotometer 2 as the second detected intensity distribution (step S7). FIG. 9 shows relation between the detected intensity and wavelength 2 as a second detected intensity distribution E2. Intensity distribution obtaining unit 310 has obtained second detected intensity distribution E2 stored in storage 320 (step S8).

Radiation intensity calculator 330 calculates the radiation intensity at each wavelength of irradiation light source 1 with a method below, based on first detected intensity distribution E1, second detected intensity distribution E2, and the radiation characteristics of standard light source 1S stored in storage 320 (step S9). Each wavelength in the present example means a constant wavelength section divided at specific pitches.

First detected intensity distribution E1 is expressed in an expression below, where Fstd represents the radiation characteristics of standard light source 1S and Fmono represents wavelength sensitivity distribution characteristics of spectrophotometer 2.

$$E 1 = Fstd \times Fmono \qquad ( 1 )$$

Second detected intensity distribution E2 is expressed in an expression below, where Firr represents the radiation characteristics of irradiation light source 1. Radiation characteristics Firr of irradiation light source 1 represent the radiation intensity distribution of light generated by irradiation light source 1. Radiation characteristics Firr include the radiation intensity at each wavelength of irradiation light source 1.

$$E 2 = Firr \times Fmono \qquad ( 2 )$$

An expression below is obtained based on the expressions (1) and (2) above.

$$E 1 / E 2 = ( F s td \times Fmono ) / ( Firr \times Fmono ) \qquad ( 3 )$$

An expression below is obtained based on the expression (3) above.

$$Firr = ( E 2 / E 1 ) \times Fstd \qquad ( 4 )$$

First detected intensity distribution E1 and radiation characteristics Fstd of standard light source 1S have already been known. Therefore, spectrophotometer 2 capable of detection of an intensity of light at each wavelength can be used to obtain second detected intensity distribution E2 of irradiation light source 1 to thereby calculate radiation characteristics Firr of irradiation light source 1 based on the expression (4) above. Thus, the radiation intensity at each wavelength not only of a light source that generates light having a specific wavelength but also of a light source that generates light having a specific wavelength range, a light source that generates multi-wavelength light, or a light source that generates white light can be obtained.

Specifically, radiation intensity calculator 330 can calculate the radiation intensity at each wavelength of irradiation light source 1 with a method below.

As shown in FIG. 10, first detected intensity distribution E1 and second detected intensity distribution E2 are divided into a plurality of wavelength sections at constant wavelength pitches. Radiation intensity calculator 330 calculates an area under first detected intensity distribution E1 and an area under second detected intensity distribution E2 in each wavelength section. In FIG. 10, E1i represents an area under first detected intensity distribution E1 in a wavelength section of first detected intensity distribution E1 and E2i represents an area under second detected intensity distribution E2 in a wavelength section of second detected intensity distribution E2, where i represents a natural number. In this case, areas of a plurality of wavelength sections of first detected intensity distribution E1 are expressed as E11, E12, . . . , E1i, and . . . Areas of a plurality of wavelength sections of second detected intensity distribution E2 are expressed as E21, E22, . . . E2i, and . . . Fstdi represents the radiation intensity of standard light source 1S in a wavelength section.

Radiation intensity calculator 330 calculates a radiation intensity Firri of irradiation light source 1 at any wavelength based on an expression below (step S9).

$$Firri = ( E 2 i / E 1 i ) \times Fstdi \qquad ( 5 )$$

The number of irradiated photons Nirr (λ) at wavelength λ is defined in an expression below with a Planck constant h, a light velocity c, and radiation intensity Firri, based on the Einstein energy equation. In the present embodiment, wavelength λ corresponds to an ith wavelength section.

$$Nirr ( λ ) = ( λ / hc ) \times Firri \qquad ( 6 )$$

Irradiated photon number calculator 340 calculates the number of irradiated photons Nirr(λ) at each wavelength λ based on the expression (6) above, with radiation intensity Firri in each wavelength section calculated in the expression (5) above (step S10). Irradiated photon number calculator 340 has the calculated number of irradiated photons Nirr(λ) at each wavelength λ stored in storage 320 (step S11). The first measurement operation is thus completed.

In the second measurement operation, the user sets sample S in sample cell 3 of measurement unit 10 (FIG. 1). Operation controller 350 determines whether or not the second measurement operation has been indicated through operation unit 40 (step S12). When the second measurement operation has been indicated, operation controller 350 controls measurement light source 21 of spectrophotometer 2 so as to irradiate the sample in sample cell 3 with light as measurement light (step S13). Operation controller 350 controls irradiation light source 1 to irradiate the sample in sample cell 3 with light as excitation light (step S14). Photons of excitation light emitted by irradiation light source 1 are thus absorbed by sample S and a photoreaction occurs. In this case, the number of absorbed photons is dependent on wavelength λ. Detector 22 of spectrophotometer 2 detects the intensity distribution of light from sample S.

Absorbance spectrum obtaining unit 360 obtains the intensity distribution of light detected by detector 22 of spectrophotometer 2 as an absorbance spectrum (step S15). Absorbance spectrum obtaining unit 360 has the obtained absorbance spectrum stored in storage 320 (step S16). During a measurement period, sample S is irradiated with excitation light having the number of irradiated photons Nirr(λ) by irradiation light source 1. The photoreaction proceeds in accordance with this number of irradiated photons Nirr(λ). Therefore, absorbance spectrum obtaining unit 360 obtains the absorbance spectrum which is time-series data. Abs(t, λ) represents the absorbance spectrum at a time point t. Nabs(t, λ) represents the number of photons absorbed at wavelength λ by sample S at time point t. The number of absorbed photons Nabs(t, λ) is expressed in an expression below.

$$( Nabs ( t , λ ) = α \times ( 1 - 1 {0}^{- A b s ( t , λ )} ) \times N i r r ( λ ) \qquad ( 7 )$$

In the expression (7) above, α is a coefficient for correction of a component of irradiation light reflected by sample cell 3. Absorbed photon number calculator 370 calculates the number of absorbed photons Nabs(t, λ) based on the expression (7) above with the use of the number of irradiated photons Nirr(λ) calculated by irradiated photon number calculator 340 and absorbance spectrum Abs(t, λ) obtained by absorbance spectrum obtaining unit 360 (step S17). Absorbed photon number calculator 370 has the calculated number of absorbed photons Nabs(t, λ) stored in storage 320 (step S18). The second measurement operation is thus completed.

Operation controller 350 then determines whether or not end of operation has been indicated through operation unit 40 (step S19). When end of operation has not been indicated, operation controller 350 returns to step S1. When the standard data obtaining operation is not indicated in step S1, operation controller 350 proceeds to step S5. When the first measurement operation is not indicated in step S5, operation controller 350 proceeds to step S12. When the second measurement operation is not indicated in step S12, operation controller 350 proceeds to step S19. When end of operation is indicated in step S19, operation controller 350 quits the photoreaction evaluation operation.

A quantum yield in a photoreaction can be calculated with the use of the number of molecules of a substance (an atom or a molecule) generated in the photoreaction in sample S and the number of absorbed photons calculated in the second measurement operation. The number of molecules of the substance generated in the photoreaction in sample S can be obtained, for example, by analysis of sample S with a gas chromatograph or a liquid chromatograph.

### (4) Effects of Embodiment

In photoreaction evaluation apparatus 100 according to the present embodiment, first detected intensity distribution E1 obtained with the use of standard light source 1S that generates white light includes a detected intensity at each wavelength in a wide wavelength range, and radiation characteristics Fstd of standard light source 1S include a radiation intensity at each wavelength in a wide wavelength range. Therefore, the radiation intensity at each wavelength in the wavelength range of irradiation light from irradiation light source 1 can accurately be calculated during the first measurement operation. The number of irradiated photons at each wavelength in the wavelength range of irradiation light from irradiation light source 1 can thus accurately be calculated.

Consequently, not only when irradiation light source 1 that generates light having a specific wavelength is used but also when irradiation light source 1 that generates light having a wide wavelength range is used, a distribution of the number of irradiated photons dependent on the wavelength can accurately be calculated.

Since the number of irradiated photons at each wavelength in the wavelength range of irradiation light from irradiation light source 1 is accurately calculated during the first measurement operation, the number of photons absorbed at each wavelength in the wavelength range of irradiation light from irradiation light source 1 can accurately be calculated during the second measurement operation.

Furthermore, first detected intensity distribution E1 obtained at the time when the standard data is obtained is stored in storage 320. Thus, first detected intensity distribution E1 does not have to be detected with the use of standard light source 1S during the first measurement operation. Therefore, time and efforts required for the first measurement operation are reduced.

Since the white light source is employed as standard light source 1S, a light source that generates light various in wavelength or wavelength range can be employed as irradiation light source 1. The number of irradiated photons at each wavelength of various irradiation light sources 1 can thus accurately be calculated. Therefore, the number of photons absorbed by sample S can accurately be calculated with the use of light having a desired wavelength.

### (5) Another Embodiment

Though the position of sample cell 3 corresponds to the sample position in the embodiment, the sample position is not limited to the position of sample cell 3 and a position of another sample holding portion or a sample support portion where sample S is held or supported may be applicable.

Data processing unit 30 of photoreaction evaluation apparatus 100 may be implemented by a personal computer, a portable electronic terminal such as a smartphone, or a server connected to a network.

### (6) Aspects

Illustrative embodiments described above are understood by a person skilled in the art as specific examples of aspects below.

(Clause 1) A photoreaction evaluation apparatus according to one aspect is a photoreaction evaluation apparatus that evaluates a photoreaction of a sample arranged at a sample position, and the photoreaction evaluation apparatus may include an irradiation light source arranged to irradiate the sample position with light as irradiation light and provided as being replaceable with a standard light source that generates white light, a uniform irradiation lens attached to the irradiation light source, the uniform irradiation lens allowing irradiation of a surface at the sample position with light at a uniform intensity, a spectrophotometer including a measurement light source and a detector, the measurement light source being arranged to irradiate the sample position with light, the detector being arranged to detect an intensity distribution of light from the sample position, an intensity distribution obtaining unit that obtains as a first detected intensity distribution, an intensity distribution of light detected by the detector while the sample position where no sample is present is irradiated with light by the standard light source and the sample position is not irradiated with light by the measurement light source and obtains as a second detected intensity distribution, an intensity distribution of light detected by the detector during a first measurement operation while the sample position where no sample is present is irradiated with light as the irradiation light by the irradiation light source and the sample position is not irradiated with light by the measurement light source, a radiation intensity calculator that calculates a radiation intensity at each wavelength of irradiation light from the irradiation light source based on the first detected intensity distribution obtained by the intensity distribution obtaining unit, the second detected intensity distribution obtained by the intensity distribution obtaining unit, and radiation characteristics of the standard light source, and an irradiated photon number calculator that calculates as the number of irradiated photons, the number of photons at each wavelength of irradiation light from the irradiation light source based on the radiation intensity at each wavelength calculated by the radiation intensity calculator. The measurement light source may be arranged on a rear surface side of a surface at the sample position irradiated with light by the irradiation light source. The detector may be arranged on a front surface side of the surface at the sample position irradiated with light by the irradiation light source.

According to the photoreaction evaluation apparatus described in Clause 1, the first detected intensity distribution obtained with the use of the standard light source is obtained. The radiation characteristics of the standard light source have already been known. During the first measurement operation, the intensity distribution of light detected by the detector while the sample position is irradiated with light by the irradiation light source is obtained as the second detected intensity distribution. Furthermore, the radiation intensity at each wavelength of irradiation light from the irradiation light source is calculated based on the obtained first detected intensity distribution, the obtained second detected intensity distribution, and the radiation characteristics of the standard light source. The number of irradiated photons of the irradiation light source is calculated based on the calculated radiation intensity at each wavelength.

In this case, the first detected intensity distribution obtained with the use of the standard light source that generates white light includes the intensity detected at each wavelength in a wide wavelength range, and the radiation characteristics of the standard light source include the radiation intensity at each wavelength in the wide wavelength range. Therefore, the radiation intensity at each wavelength in the wavelength range of irradiation light from the irradiation light source can accurately be calculated during the first measurement operation. The number of irradiated photons at each wavelength in the wavelength range of irradiation light from the irradiation light source can thus accurately be calculated.

Consequently, not only when the irradiation light source that generates light having a specific wavelength is used but also when the irradiation light source that generates light having a wide wavelength range is used, the distribution of the number of irradiated photons dependent on the wavelength can accurately be calculated.

The photoreaction evaluation apparatus described in Clause 1 can measure the number of photons even when sample S set in sample cell 3 is a film sample or a sample in a form of a film, owing to arrangement of the measurement light source on the rear surface side of the surface at the sample position irradiated with light by the irradiation light source and arrangement of the detector on the front surface side of the surface at the sample position irradiated with light by the irradiation light source.

(Clause 2) In the photoreaction evaluation apparatus described in Clause 1, the measurement light source and the detector may be arranged at positions opposed to each other with the sample position lying therebetween.

According to the photoreaction evaluation apparatus described in Clause 2, since light from the measurement light source passes through the sample and then enters the detector, accuracy in measurement of the number of photons is improved.

(Clause 3) In the photoreaction evaluation apparatus described in Clause 2, an angular difference between a direction of irradiation with light by the irradiation light source and a direction of irradiation with light by the measurement light source may be within a prescribed range.

According to the photoreaction evaluation apparatus described in Clause 3, light from the irradiation light source is less likely to affect light from the measurement light source.

(Clause 4) In the photoreaction evaluation apparatus described in Clause 2, a direction of irradiation with light by the irradiation light source and a direction of irradiation with light by the measurement light source may be in parallel to each other.

According to the photoreaction evaluation apparatus described in Clause 4, light from the irradiation light source is less likely to affect light from the measurement light source.

(Clause 5) The photoreaction evaluation apparatus according to any one of Clauses 1 to 4 may further include an absorbance spectrum obtaining unit that obtains as an absorbance spectrum, an intensity distribution of light detected by the detector during a second measurement operation while a sample at the sample position is irradiated with light by the measurement light source and the sample at the sample position is irradiated with light by the irradiation light source, and an absorbed photon number calculator that calculates as the number of absorbed photons, the number of photons absorbed at each wavelength by the sample based on the number of irradiated photons calculated by the irradiated photon number calculator and the absorbance spectrum obtained by the absorbance spectrum obtaining unit during the second measurement operation.

According to the photoreaction evaluation apparatus described in Clause 5, during the second measurement operation, the intensity distribution of light detected by the spectrophotometer while the sample at the sample position is irradiated with light by the irradiation light source is obtained as the absorbance spectrum. The number of absorbed photons is calculated based on the number of irradiated photons and the absorbance spectrum. In this case, the number of irradiated photons at each wavelength in the wavelength range of irradiation light from the irradiation light source is accurately calculated during the first measurement operation. Therefore, the number of photons absorbed at each wavelength in the wavelength range of irradiation light from the irradiation light source can accurately be calculated.

(Clause 6) The photoreaction evaluation apparatus according to Clause 5 may further include a storage where the first detected intensity distribution obtained by the intensity distribution obtaining unit is stored before the first measurement operation and the second measurement operation, and the intensity distribution obtaining unit may obtain the first detected intensity distribution stored in the storage during the first measurement operation.

According to the photoreaction evaluation apparatus described in Clause 6, the first detected intensity distribution obtained before the first measurement operation and the second measurement operation is stored in the storage. Detection of the first detected intensity distribution with the use of the standard light source during the first measurement operation thus does not have to be performed. Therefore, time and efforts required for the first measurement operation are reduced.

(Clause 7) In the photoreaction evaluation apparatus according to any one of Clauses 1 to 6, a light source that generates white light, monochromatic light, or light having a constant wavelength range may selectively be provided as the irradiation light source.

According to the photoreaction evaluation apparatus described in Clause 7, a light source that generates light various in wavelength or wavelength range can be employed as the irradiation light source. A photoreaction of various samples can thus accurately be evaluated with the use of light having a desired wavelength.

It should be understood that the embodiment disclosed herein is illustrative and non-restrictive in every respect. The scope of the present invention is defined by the terms of the claims rather than the description of the embodiment above and is intended to include any modifications within the scope and meaning equivalent to the terms of the claims.

### REFERENCE SIGNS LIST

1 . . . irradiation light source; 1S . . . standard light source; 2 . . . spectrophotometer; 3, 3A . . . sample cell; 10, 10A . . . measurement unit; 21 . . . measurement light source; 22 . . . detector; 30 . . . data processing unit; 31 . . . CPU; 32 . . . RAM; 33 . . . ROM; 34 . . . input and output I/F; 35 . . . storage; 36 . . . bus; 40 . . . operation unit; 50 . . . display; 100, 100A . . . photoreaction evaluation apparatus; 310 . . . intensity distribution obtaining unit; 320 . . . storage; 330 . . . radiation intensity calculator; 340 . . . irradiated photon number calculator; 350 . . . operation controller; 360 . . . absorbance spectrum obtaining unit; 370 . . . absorbed photon number calculator; 380 . . . representation controller; E1, E2 . . . detected intensity distribution; S, SA . . . sample

1. A photoreaction evaluation apparatus that evaluates a photoreaction of a sample arranged at a sample position, the photoreaction evaluation apparatus comprising:
an irradiation light source arranged to irradiate the sample position with light as irradiation light and provided as being replaceable with a standard light source that generates white light;
a uniform irradiation lens attached to the irradiation light source, the uniform irradiation lens allowing irradiation of a surface at the sample position with light at a uniform intensity;
a spectrophotometer including a measurement light source and a detector, the measurement light source being arranged to irradiate the sample position with light, the detector being arranged to detect an intensity distribution of light from the sample position;
an intensity distribution obtaining unit that obtains as a first detected intensity distribution, an intensity distribution of light detected by the detector while the sample position where no sample is present is irradiated with light by the standard light source and the sample position is not irradiated with light by the measurement light source and obtains as a second detected intensity distribution, an intensity distribution of light detected by the detector during a first measurement operation while the sample position where no sample is present is irradiated with light as irradiation light by the irradiation light source and the sample position is not irradiated with light by the measurement light source;
a radiation intensity calculator that calculates a radiation intensity at each wavelength of irradiation light from the irradiation light source based on the first detected intensity distribution obtained by the intensity distribution obtaining unit, the second detected intensity distribution obtained by the intensity distribution obtaining unit, and radiation characteristics of the standard light source; and
an irradiated photon number calculator that calculates as the number of irradiated photons, the number of photons at each wavelength of irradiation light from the irradiation light source based on the radiation intensity at each wavelength calculated by the radiation intensity calculator, wherein
the measurement light source is arranged on a rear surface side of a surface at the sample position irradiated with light by the irradiation light source, and
the detector is arranged on a front surface side of the surface at the sample position irradiated with light by the irradiation light source.

2. The photoreaction evaluation apparatus according to claim 1, wherein
the measurement light source and the detector are arranged at positions opposed to each other with the sample position lying between the measurement light source and the detector.

3. The photoreaction evaluation apparatus according to claim 2, wherein
an angular difference between a direction of irradiation with light by the irradiation light source and a direction of irradiation with light by the measurement light source is within a prescribed range.

4. The photoreaction evaluation apparatus according to claim 2, wherein
a direction of irradiation with light by the irradiation light source and a direction of irradiation with light by the measurement light source are in parallel to each other.

5. The photoreaction evaluation apparatus according to claim 1, further comprising:
an absorbance spectrum obtaining unit that obtains as an absorbance spectrum, an intensity distribution of light detected by the detector during a second measurement operation while a sample at the sample position is irradiated with light by the measurement light source and the sample at the sample position is irradiated with light by the irradiation light source; and
an absorbed photon number calculator that calculates as the number of absorbed photons, the number of photons absorbed at each wavelength by the sample based on the number of irradiated photons calculated by the irradiated photon number calculator and the absorbance spectrum obtained by the absorbance spectrum obtaining unit during the second measurement operation.

6. The photoreaction evaluation apparatus according to claim 5, further comprising a storage where the first detected intensity distribution obtained by the intensity distribution obtaining unit is stored before the first measurement operation and the second measurement operation, wherein
the intensity distribution obtaining unit obtains the first detected intensity distribution stored in the storage during the first measurement operation.

7. The photoreaction evaluation apparatus according to claim 1, wherein
a light source that generates white light, monochromatic light, or light having a constant wavelength range is selectively provided as the irradiation light source.
